(19) United States
(12) Patent Application Publication
(10) Pub. No.: US 2003/0054062 A1
(43) Pub. Date: Mar. 20, 2003

(54) BASE FOR FOAM PATTERN TOOLS

(76) Inventor: TERRY E. AUSTIN, QUINCY, IL (US)

Correspondence Address: JOSEPH W HOLLOWAY, 8832 WHITE OAK ROAD, LIBERTY, IL, 62347

(21) Appl. No.: 09/474,617

(22) Filed: Dec. 29, 1999

(51) Int. Cl. B29C 33/30

(52) U.S. Cl. 425/193; 249/155; 249/157

(57) ABSTRACT

A pair of frame members are connected in laterally spaced, parallel relation; and, when mounted on a molding machine, the frames extend perpendicularly to the centerline of the machine's mandrels. A major center portion of each frame is excised to provide a pair of aligned window-like openings surrounded by perimetric portions of the frames. Actuators are secured between the spaced frame members and have extensible piston rods attached to mold segments for advancing and retracting the same within the openings. Movement of a machine platen occurs along an axis which penetrates the openings; and, piston rod movement is generally normal to movement of the platen.

### TECHNICAL FIELD

This invention pertains generally to an apparatus for molding single-piece foam patterns used in lost foam pattern casting. More particularly, the invention relates to an improved base for mounting pattern forming tools on a molding machine.

### BACKGROUND OF THE INVENTION

Tools for making foam patterns and their application are well understood by tool designers, tool makers, and pattern molders and need not be described herein in great detail; however, the general characteristics of currently used tools will be briefly set forth to provide an understanding of how they differ from the present invention.

Typical foam pattern tools include at least the following structural elements:

1. Plural mold segments having machined or cast recesses which coact when closed together to define a molding cavity for receiving expandable pattern material such as polystyrene beads and for shaping such material to the exact configuration of the cavity.

2. Wall portions of each mold segment extend rearwardly from its pattern-forming front face to define an integral chest for receiving molding process fluids including steam, cooling water and air.

3. A generally flatback plate is removably secured over the open back side of the chest to close and seal the same.

4. Each of the backplates employed for sealing the chest of the individual mold segments is, in turn, secured to a baseplate mountable on a molding machine.

5. Associated with the mold segments, the backplates and the baseplates are various alignment pins and pin bushings which interfit to insure that the mold segments align correctly when closed and clamped by the molding machine or by auxiliary fluid-actuated cylinders.

6. Bead injection conduits leading from air-actuated bead filling guns usually extend through one or more of the aforesaid chests and then penetrate the molding cavity wall to fill the same with partially expanded pattern material.

7. Various venting devices are placed in the walls of the mold segments to vent air from a closed molding cavity as it fills with pattern material.

8. The chests defined by the back surfaces of the mold segments and coacting backplates are provided with service fittings and connectors for pattern forming media, i.e. foam beads, steam, water and air.

The enumerated tool components are structurally arranged and assembled to provide an individual foam pattern making assembly known as a self-contained tool. In its simplest form, a self-contained, single-axis tool having only two mold segments somewhat resembles the opposed halves of a box. The mold segments are mounted on the movable and stationary platens of a molding machine for sequentially opening, closing and clamping the segments during the molding operation. The molding machine not only supports the box-like tool, but also carries the cavity filling equipment and service lines and drains which are respectively connected to the molding cavity and to the utility chests defined by the box halves.

In more complex self-contained tools, provision is made for opening and closing opposed mold segments by means other than single-axis motion of the platens of the molding machine. For example, known tools for forming the molding cavity for a cylindrical pattern may employ three sets of opposed mold segments which operate normally to each other. The cylindrical exterior wall of the mold cavity is defined by two opposed sets of concave cylindrical quadrants; and, the top and bottom walls of the molding cavity are established by opposed cylindrical mandrels which are movable between the quadrants perpendicularly to the direction of quadrant opening and closing. A complex three-axis, six-segment tool may be largely contained within the walls of a substantially closed box-like housing supported on a molding press. In this tool configuration, each of a first set of opposed mold segments has baseplates respectively fixed to the stationary platen and movable platen of the molding machine. Each of the four remaining mold segments or pulls is enclosed within the box-like tool housing and is operable for opening and closing reciprocation by means of fluid operated actuators connecting the baseplate of each segment to an adjacent box wall.

Self-contained foam pattern tools of the more complex, multiple-axis type require substantial time and expense to design, build, install and maintain. Nevertheless, such greater expenditures of money and time are economically justifiable by increases in pattern design flexibility and quality as well as the ability of complex tools to produce large quantities of consistently acceptable patterns at high production rates. In designing a self-contained tool, primary consideration must be given to the precise configuration, close dimensional tolerances, and surface finish of the pattern to be produced; however, many other tool design considerations can directly affect the pattern-forming operation performed within the tool's mold cavity. For example, means providing efficient cavity alignment and filling; proper locations and connections for utilities, vents and drains; the operating and service capabilities of the molding machine; and, means for inter-connecting the mold cavities, the tool base, and the molding machine structure all importantly define the tool's molding capabilities and effectiveness. Because tools must incorporate structural and operational features responsive to many design demands, individual patterns, except those of the most simple configuration, require a different molding tool comprising a one-of a-kind assemblage of component parts.

For pattern molders, the singular nature of each self-contained tool has presented long-recognized, but heretofore unsolved problems, namely: Modification of an existing tool for the purpose of producing a differently sized or configured pattern requires that most, if not all, of its interdependent elements be redesigned and rebuilt at substantial expense and with accompanying delay. Furthermore, the cost entailed in owning and maintaining a minimal inventory of different self-contained pattern tools must be either absorbed by the molder or passed on to his customer as an increase in the price of the finished pattern. An unavoidably large investment of capital in unproductive pattern tools can seriously limit the profitability and growth potential of a molding concern.

Even if a variety of pattern tools are available from the molder's tool inventory, the interchange of a pattern tool from inventory for another mounted on a molding machine is an arduous, time-consuming task usually performed by specially trained work crews. Molding machine downtime due to long tool change-out times and accompanying pattern production losses also increase the production cost of each pattern piece in the following significant regards: To reduce the frequency of tool changes, minimum production runs of each pattern are usually made with excess patterns being stored at the molder's expense until paid for and delivered to the user. Molding machine downtime reduces the molder's total molding capacity without reducing overhead expense; and, downtime may also require him to invest in additional molding equipment and shop floor space. Profit opportunities presented by short production runs are not available unless a molder can absorb or pass on the aforenoted downtime costs occasioned by frequent tool changes. Frequent tool replacements inevitably increase wear and tear on the tools elements and the tool supports of the molding machine.

Besides the cost problems attributable to machine downtime, other problems are encountered each time a complex tool is replaced. Many of these other problems are directly attributable to the bulk and weight of three-axis tools employed for molding large patterns and multi-cavity patterns. In the three-axis tools in use today, the four backplates of two opposed sets of mold segments are attached to extendable piston rods of actuators which are, in turn, mounted on the baseplates associated with the backplates. The backplates of the remaining two mold segments are attached to associated baseplates which, in turn, are respectively connected to the stationary and movable platens of the molding machine. The aforedescribed six baseplates are structurally joined to form the walls of a six-sided structure which houses the molding segments of the tool and serves as a mounting base for the complete tool for attaching the same to some supportive molding machine structure. The connected baseplates forming the box-like tool base are necessarily of substantial length in order to provide the actuators which they support with adequate piston travel for opening the mold segments sufficiently for removal of finished patterns. These elongated baseplates are likewise quite thick in order to provide tool strength and stability; therefore, the total tool weight, even where lightweight metal, such as aluminum, is used extensively for the molds, backplates and baseplates, may reach several hundred pounds. Thus, the weight and bulk of a tool mounted on a press by means of a conventional box-like tool base is such that tool change out crews have difficulty in installing and removing these unwieldly tools. Special lifting and positioning devices are often required to set up or change-out such tools. Moreover, personnel performing this task must be specially trained and closely supervised to minimize risk of personal injury and molding machine damage.

Additional time-consuming procedures are usually encountered in mounting and connecting a complex three-axis tool to a typically configured molding machine. For example, numerous tool-to-machine alignment and locking devices must be installed and carefully adjusted to assure mold segment stability and alignment accuracy for correct cavity closure. A myriad of conduits and connectors must be routed and secured between all utility services and the inlet fittings of mold cavities, mold chests and mold segment actuators. The box-like nature of conventional tools greatly reduces access to interior components and hampers the installation and subsequent maintenance and repair of such tools.

The foregoing recitation of problems that molders of foam patterns often encounter in altering the molding cavity of a pattern tool or in removing a tool from a molding machine and replacing it with another, highlights the need for a means for exchanging a tool's mold segments while the remainder of the tool itself remains mounted on the machine.

### SUMMARY OF THE INVENTION

The general object of this invention is to provide a solution to the hereinabove recited problems commonly associated with the design, construction and use of prior art foam pattern molding tools.

Another broad object is to provide a tool base which is simpler, lighter in weight and adaptable for a broader range of uses than the box-like bases described above. To this end, a base according to this invention essentially comprises an open frame which encircles, but does not enclose, the elements of a pattern tool supported thereon. More particularly, such a base includes an open frame which affords great flexibility in the orientation of various types of mold segments and their associated actuators in order to meet the requirements of highly complex pattern designs.

To obviate other shortcomings of known tool bases, this invention contemplates a tool base having these key features: Firstly, different sets of mold segments can be interchangeably mounted on a single base without alteration of other tool elements carried by the base. Secondly, one set of mold segments can be changed out with another set while the tool base remains mounted on a molding press and stays connected to various service lines. In many cases, easily accessible, light weight mold segments can be quickly exchanged through the effort of a single workman.

Another important aspect of this invention is the provision of a highly adaptable tool base which serves as a common structural interface between a molding machine and a number of interchangeable sets of mold segments thereby facilitating the production of a series of patterns which are generally similar in shape and graduated in size. Tool bases having this capability can be used to great advantage for producing patterns required for cast parts such as housings for electric motors and cylinders for air compressors.

A further object is realized by an improved tool base which provides the functions of a conventional box-like base yet weighs less than one half as much thereby dramatically reducing the physical effort, time and expense heretofore involved in installing and exchanging self-contained tools in a molding machine.

In basic form, the tool base of this invention includes at least one metal plate having a window therethrough defined by a perimetric frame. Plural mold segments and actuators therefore are carried by the frame with the cavity-forming recesses of the segments directed toward the window opening.

The following detailed disclosure of illustrative embodiments of the invention will show that the tool base may include a pair of frame members connected in spaced, parallel relation; and, when mounted on a molding machine, these frames extend perpendicularly to the centerline of the machine's mandrels. A major center portion of each frame is excised to provide a pair of aligned window openings surrounded by perimetric portions of the frames. Fluid powered actuators are secured between the spaced frame members and have extensible piston rods attached to mold segments for advancing and retracting the same. Movement of the machine platen occurs along an axis which passes through the window opening; and, piston rod movement is usually normal to movement of the platen.

Still another object of this invention is the provision of a base for a pattern tool wherein the base includes an open frame having a separable portion that is selectively movable for repositioning such portion and a finished pattern piece attached thereto to permit removal of the finished piece from the tool.

These and other advantages and objects of this invention and the manner of obtaining them will become apparent and the invention will be best appreciated and fully understood by having reference to the following detailed description taken in conjunction with the accompanying drawings.

### DETAILED DESCRIPTION OF THE DRAWINGS

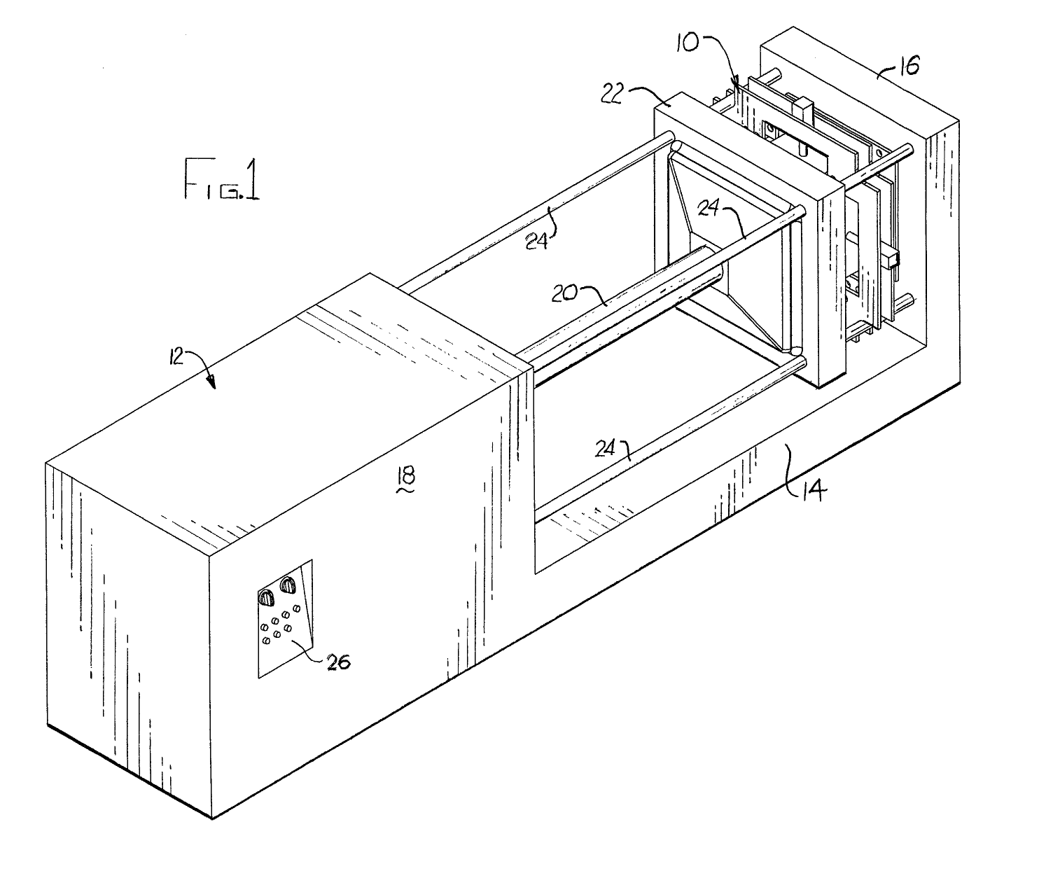

FIG. 1 is a perspective view of a molding machine of the type commonly employed to operate foam pattern molding tools;

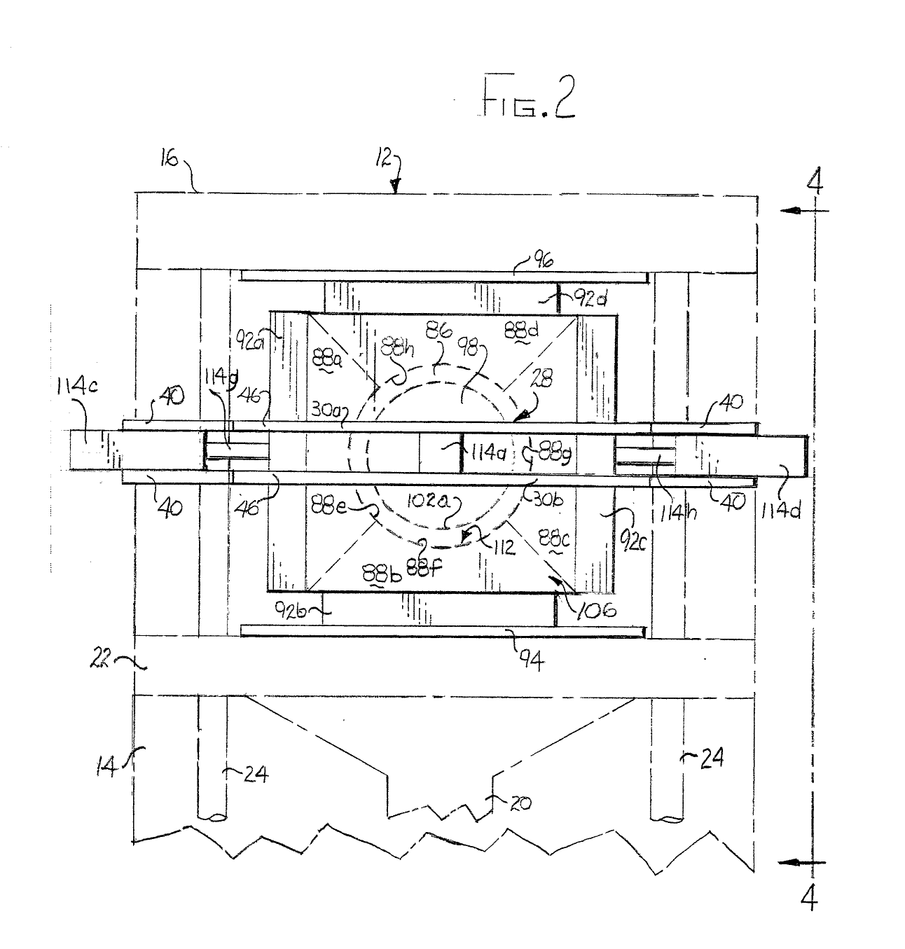

FIG. 2. is a top plan view of the tool with a fragment of the molding machine shown in phantom lines;

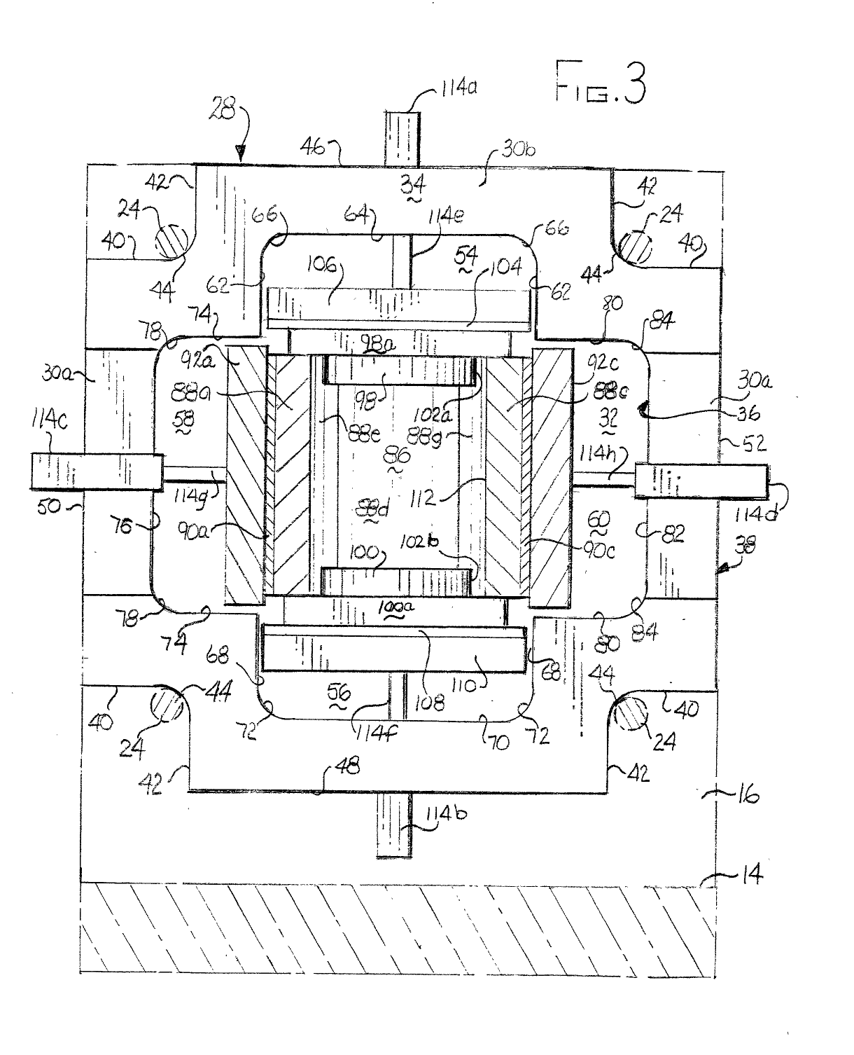

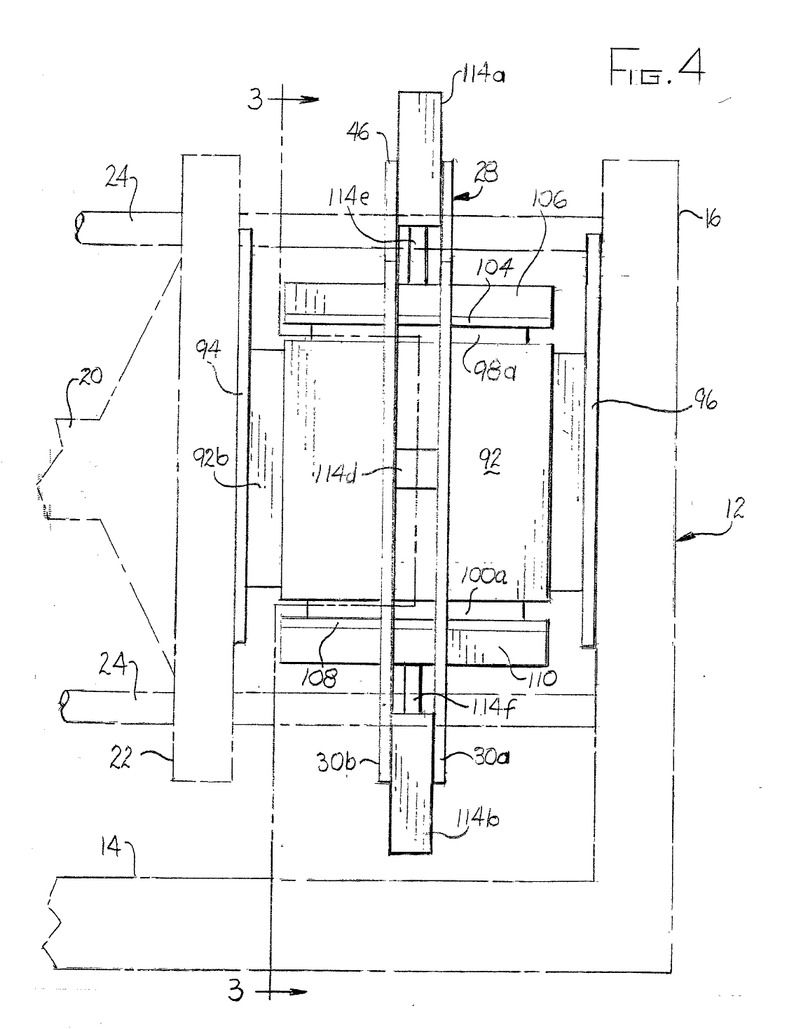

FIG. 3 is a section of taken along lines 3-3 of FIG. 4;

FIG. 4 is a side elevational view taken generally along lines 4-4 of FIG. 2;

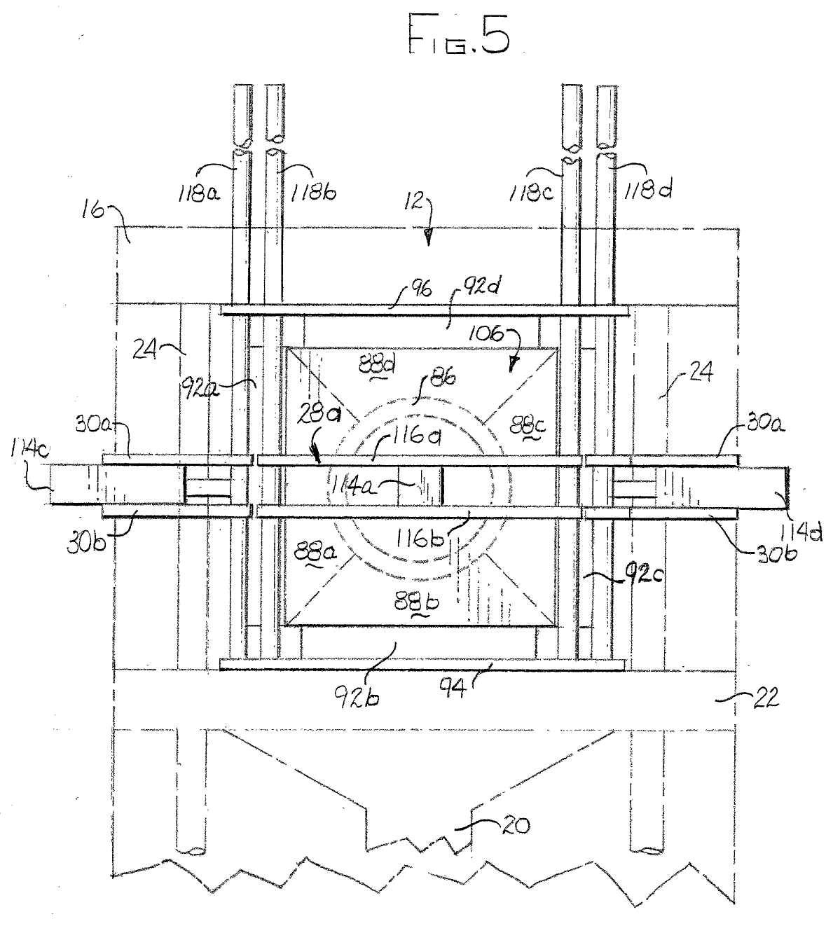

FIG. 5 is a top plan view similar to FIG. 3 showing a modified embodiment of the invention; and,

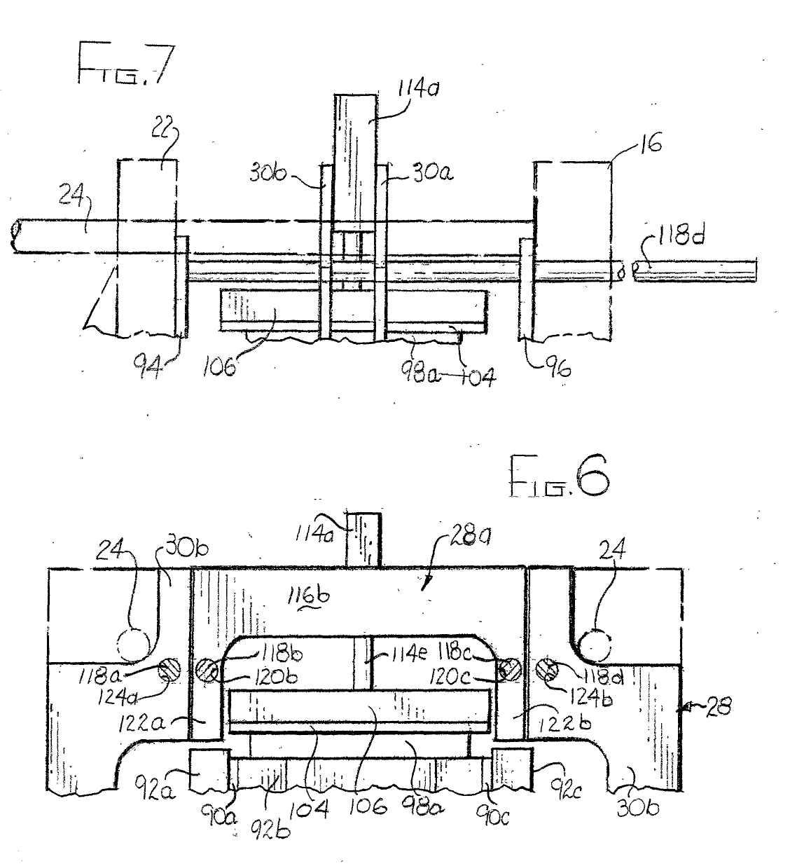

FIGS. 6 and 7 are fragmentary views of the modified embodiment shown in FIG. 5.

### DETAILED DESCRIPTION OF THE INVENTION

The foam pattern molding tool 10 disclosed herein is mounted on and operated by a molding machine of a well-known type shown in outline in FIG. 1 and designated in its entirety by numeral 12. The machine 12 not only supports the tool 10, but is structurally stable, has smooth operation and has platens that move in parallel for dimensional accuracy. The machine 12 is generally U-shaped and has a bed 14, a stationary platen 16 and a machinery area 18 including a hydraulically actuated ram the extensible piston 20 of which carries a movable platen 22. The platen 22 is penetrated by bars or rods 24 fixed between the housing 18 and platen 16; and, such bars slidably support the platen 22 as it is advanced and retracted relative to platen 16 by the action of piston 20. Conventional controls 26 for the machine 12 are operable to provide bead filling, to heat and cool the molding cavities of the tool 10 and to actuate various mechanisms which open and close these cavities. In a well understood manner, the controls 26 regulate the supply of foam beads to the tool cavities and the flow of steam and cooling water to the chests adjacent the cavities. Compressed air may be furnished to the cavities to eject finished patterns; and, hydraulic fluid or compressed air is directed to pressure fluid actuator devices for operating various mold pulls. The supply lines and control lines required to interconnect the sources of molding beads, steam, water, air and hydraulic pressure fluid to the molding machine 12 and to the tool 10 are not shown in the drawings since their structure and function are disclosed in the prior art relavant to molding machines and foam pattern tools.

As best illustrated in FIG. 1, the tool 10 is mounted on the machine 12 intermediate the platens 16 and 22. A hopper, not shown, containing a supply of foam beads may be conveniently mounted upon the upper surface of platen 16 with the hopper outlet connected to tool 10 in a manner to be described.

The preferred embodiment of the invention depicted in the drawings comprises a base 28 which includes a pair of like plates 30a, 30b that are joined in spaced, parallel relation, as best shown in FIGS. 2 and 4. In lateral profile, the plates 30a, 30b resemble windows having open centers 32 surrounded by perimetric frames 34; and, the frames have continuous inner and outer perimetric edges indicated in FIG. 3 at 36 and 38, respectively. At its four corners, the outer edge 38 of each frame is defined by a horizontal edge 40, a vertical edge 42 and a connecting curved edge 44. The parallel top and bottom edges 46 and 48 extend horizontally between spaced vertical edges 42 and the parallel side edges 50 and 52 connect spaced horizontal edges 40. The inner edges 36 of the plates 30a and 30b define four angularly spaced recesses 54, 56, 58 and 60 which open toward one another and into the frame center 32. The upper recess 54 is defined by spaced vertical edges 62 and horizontal edge 64 which are connected by curved edges 66. The lower recess 56 is defined by spaced vertical edges 68, horizontal edge 70 and curved edges 76. One lateral recess 58 is defined by spaced horizontal edges 74, vertical edge 76 and curved edges 78; and, the opposed lateral recess 60 is defined by horizontal edges 80, vertical edge 82 and curved edges 84.

A principal function of the tool base 28 is to provide means for supporting the plural mold segments of tool 10 on the molding machine 12 in correct operating relation to one another and to the machine. One example of the manner in which mold segments are supported by the base 28 will be described in connection with an illustrative tool providing a molding cavity 86, shown in broken lines in FIG. 2. Four angularly spaced mold segments 88a,b,c,d are vertically supported by four like backplates, two of which are shown at 90a and 90c in FIG. 3. The backplates for mold segments 88a,b,c,d are respectively secured to baseplates 92a,b,c,d. As best seen in FIG. 2, the mold segment 88b is attached to baseplate 92b which, in turn, is connected to movable platen 22 by intermediate mounting plate 94. Mold segment 88d is attached to baseplate 92d which, in turn, is attached to the stationary platen 16 by intermediate mounting plate 96.

FIGS. 3 and 4, show in broken lines, upper and lower cylindrical mandrels 98 and 100 which respectfully define the inner cylindrical walls 102a and 102b of mold cavity 86. The enlarged base 98a of mandrel 98 is attached first to backplate 104 and then to baseplate 106; and, enlarged base 100a of mandrel 100 is attached first to backplate 108 and then to baseplate 110.

The various backplates, baseplates, and mounting plates mentioned above may be detachably secured to one another by suitable fasteners, not shown, which facilitate the rapid interchange of sets of mold segments and/or mandrels.

The drawings depict the aforedescribed mold segments and mandrels in their closed condition wherein the cylindrical outer wall 112 of the mold cavity 86 is defined by the contiguous concave faces 88e,f,g,h of the mold segments 88a,b,c,d; the cylindrical inner walls 102a and 102b of the cavity 86 are defined by the vertically aligned outer walls of the mandrels 98 and 100; and, the top and bottom of the cavity 86 are respectively closed by the enlarged bases 98a and 100a of the mandrels.

The manner in which the frame 28 provides a base for the operating components of tool 10 and mounts the tool on the molding machine 12 will now be set forth in detail.

The bars 24 bear against the curved frame edges 44 allowing the frame 34 to project beyond the bars which allows an increase in the size of the frames and of the tool 10 mounted thereon. Such bar-to-frame engagement supports the weight of the tool 10 while maintaining the verticality of the frame and concentricity of the frame relative to the piston 20. The frame plates 30a, 30b are rigidly held in spaced parallel relation by means of four fluid powered actuators 114a,b,c,d fixed between the plates at 90° intervals about the frame's perimeter. The elongated housings of these actuators have opposed flat side surfaces which bear against the inwardly turned sides of the plates 30a, 30b in the manner best seen in FIGS. 2 and 4. Any suitable mounting bracket or strap, not shown, may be utilized to removably secure individual actuators between the plates at the midpoints of each edge 46, 48, 50 and 52. As best shown in FIG. 3, the actuators 114a,b,c,d have extensible pistons or piston rods 114e,f,g,h which, when extended, project inwardly into frame recesses 54, 56, 58, 60 respectively. The baseplate 106 for the upper mandrel 98 is fixed to the piston 114e and is supported thereby within the recess 54 in spaced relation to the adjacent frame edges 62 and 64. Similarly, the baseplate 110 for the lower mandrel 100 is fixed to the piston 114f and is supported thereby within the recess 56 and in spaced relation with adjacent frame edges 68 and 70. The baseplate 92a for the mold segment 88a is fixed to the piston 114g and is supported thereby within the recess 58 and in spaced relation with adjacent frame edges 74 and 76. The baseplate 92c for the mold segment 88c is fixed to the piston 114h and is supported thereby within the recess 60 in spaced relation with adjacent frame edges 90 and 82. Additional mold segment stabilizing rods, not shown, may extend from their points of attachment to the baseplates 92a, 92c, 106 and 108 through cylindrical slide bearings, not shown, mounted between plates 30a, 30c on both sides of the four power actuators 114a,b,c,d.

In the positions shown in FIG. 2 of the drawings, the actuators 114c and 114d have been operated to extend their pistons and the platen 22 is fully extended whereby the mold segments 88a,b,c,d are closed in abutting relation and the mold faces 88e,f,g,h join to form the cylindrical outer cavity wall 112. The actuator pistons 114e and 114f have fully inserted the mandrels 98 and 100 thereby forming the cylindrical inner cavity walls 102a and 102b and closing the cavity at its top and bottom, as best shown in FIGS. 3 and 4.

Following operation of the molding machine controls 26 to close the molding cavity 86, foam beads are supplied by air-operated guns to the cavity 86 and process fluids are sequentially communicated to the usual chests, not shown, defined by the rear surface of each mold segment and a backplate attached thereto. The various baseplates which provide surfaces upon which the backplates can be readily attached and detached also have internal passages which function as conduits for interconnecting the interior of the mold segment chests and supply lines for pressurized steam, water and compressed air. In proper sequence and for required durations, the molding machaine operates valves which open and close the supply lines for the beads and for the various utilities required to fill the cavity, to heat and fuse the beads, and to cool and stabilize the finished pattern.

To prepare for removal of a completed pattern from the tool 10, the molding machine communicates pressure fluid to the actuators 114a,b,c,d through suitable lines to effect retraction of the actuator pistons 114e,f,g,h whereby the baseplates 92a, 92c, 106, and 108 are drawn into the recesses 54, 56, 58, and 60. Also, the machine's movable platen 22 is drawn away from stationary platen 16. These machine controlled actuations cause the mold segments 88a,b,c,d and the mandrels 98 and 100 to separate sufficiently for removal of the pattern from the tool by a mechanism for pushing the pattern from the cavity 86, by compressed air directed against the pattern surface or, alternatively, by hand.

A modified version of the frame 28 is shown in FIGS. 5, 6 and 7. In the first-described embodiment of the tool 10 shown in FIG. 3, for example, the maximum vertical displacement of the mandrel 98 is limited by the length of travel of the actuator piston 114e and/or by the vertical clearance between the top surface of baseplate 106 and the lower edge 64 of frame 28. If a longer mandrel is required for a particular pattern, the length of available vertical displacement for such a mandrel could be increased by first providing a frame 28 having a recess 54 with longer vertical walls 62 and then replacing actuating cylinder 114a with another having longer piston travel. However, such modifications may be undesirable due to the resulting increase in the vertical projection of the frame above the molding machine and less stable alignment and movement of the tool. By means of the modifications of frame 28 about to be disclosed, a mandrel longer than depicted mandrel 98 can be employed to form the inside cavity wall 102a yet such a mandrel, even with a finished cylindrical pattern still attached, is laterally separable from the remainder of tool 10 without first withdrawing the mandrel from the pattern. This is accomplished by providing a separable and independently movable top segment 28a of the frame 28 which may be selectively coupled to the platen 22 for lateral movement therewith. Such lateral movement of the segment 28a and the mandrel attached thereto is made possible by separating inverted U-shaped segments 116a and 116b from the frame plates 30a and 30b as best shown in FIG. 6. Four elongated rods 118a,b,c,d are secured to the machine platen 22 by means of the mounting plate 94 and extend toward the stationary platen 16 in parallel with the tool-mounting bars 24. The rods 118b and 118c penetrate aligned apertures 120 and 120c in the inverted legs 122a and 122b of the U-shaped segments 116a and 116b. The rods 118c and 118d penetrate aligned apertures 124a and 124b in the frame 28. All of these rods penetrate openings, not shown, through the mounting plate 96 and the stationary platen 16 and extend well beyond the platen 16.

After a pattern has been molded by a tool 10 which incorporates the modifications just described, the mold segments 88a and 88c are retracted and the lower mandrel 100 is withdrawn vertically from the completed pattern. Next, mold segment 88b, the upper mandrel, the completed pattern and the frame segment 28a are moved as a unit in response to retraction of machine piston 20. This machine controlled movement separates segment 28a from the frame 28 thereby drawing the upper mandrel 98 and the surrounding pattern away from the stationary mold segment 88d and between the retracted mold segments 88a and 88c. The rods 118a,b,c,d are drawn through the platen 16 and the mounting plate 96 as the separable frame segment 28a, mold segment 88b, mandrel 98 and pattern are all transported with the platen 22. When sensors incorporated in machine 12 detect that the lower perimetric edge of the pattern has cleared the baseplate 110 sufficiently, the frame segment 28a is automatically decoupled from the platen 22 and locked against further movement. A final increment of machine controlled platen movement will draw the rods 118b and 118c through the now stationary frame segment 28a as the mold segment 88b is drawn away from the finished pattern.

At this point in the molding operation, the tool 10 and machine 12 are idled while the finished pattern remains suspended on mandrel 98 from which it may be readily removed in the downward direction by a push-off mechanism, by compressed air or by manually pulling the same from the upper mandrel. Various position sensors, latches, couplers and the like are incorporated in the molding machine 12 and in the tool 10 for operating the modified tool in the described fashion; however all such electronic, electrical and mechanical devices are commercially available and their applications in this invention are entirely conventional.

In accordance with the illustrative embodiment, the molding tool actuators are attached to frame 28 at four evenly spaced locations about its perimeter; and, the diametrically opposed pairs of cavity forming tools carried by these actuators move along two axes which pass through the centerpoint of the frame's open center. The frame 28 is mounted on machine 12 so that the centerline of the machine's piston 20 also passes through the frame's centerpoint and is perpendicular to the actuator axes. However, this invention also contemplates a tool frame which may be differently shaped and sized from frame 28 for mounting an odd or even number of mold-segment actuators appropriate for forming very complex cavities. Furthermore, the extension and retraction of an individual actuator may occur at any desired angle with respect to that of any other actuator mounted on the frame or with respect to the axis of travel of a machine platen. Moreover, the tool 10 may be mounted on the machine 12 with the plates 30a and 30b tilted at an angle to the centerline of the machine piston 20 nor must the piston centerline coincide with the centerline of the frame opening 32. While the frame 28, as shown, is made up of a pair of spaced, parallel plates 30a and 30b having actuators 114a,b,c,d attached between and joining these plates, the advantages attributalbe to the open frame structure of this invention can be provided by a single plate having any size opening displaying any perimetric outline. The actuators could be removably attached to the single frame plate by any suitable clamp or fastener.

Other desirable structural variations of the frame element 28 of tool 10 are possible and can be achieved without sacrificing the quintessential structural feature of this invention; namely, an open-centered frame which encircles but does not enclose the cavity forming elements of the pattern tooling. The significance of this key feature of the molding tool 10 will be understood and appreciated by tool designers who will be able to devise multiple-axis molding tools using open-center frames, as taught by this invention, that are specially configured for mounting a plurality of cavity forming segments on a molding machine in unique spatial relationships and orientations required to mold highly complex patterns. Pattern molders will appreciate that the various backplates which mount mold segments inside the open frame become readily accessable to workemen when the mold-operating platens and actuators are retracted. Such accessability makes it possible to change out mold segments without demounting the tool from the molding maching merely by exchanging those backplates which attach the old and new segments to associated baseplates and possibly reconnecting bead supply lines to the new mold cavities. A single workman can manually detach and exchange relatively light weight mold segments while the tool remains mounted on the molding machine in a fraction of the machine down time entailed in the exchange of closed, box-like tools of the kind described above in the Background Of The Invention.

The foregoing description of the embodiments of the invention shown in the drawings is illustrative and explanatory only; and, various changes in the size, shape and materials, as well as in specific details of the illustrated construction, may be made without departing from the scope of the invention. Therefore, we do not intend to be limited to the details shown and described herein, but intend to cover all changes and modifications which are encompassed by the scope and spirit of the appended claims.

What we claim as our invention is:

1. A molding tool for foam patterns comprising:
a) movable cavity forming mold segments;
b) support means disposed about said segments;
c) actuating means connecting said segments with said support means in movable relationship therewith; and,
d) said support means includes at least one frame with a window-like opening.

2. The invention set forth in claim 1, wherein:
said frame encircles a cavity formed by said segments.

3. The invention set forth in claim 1, wherein:
a) said actuating means are attached to said frame and extend therefrom into said opening; and,
b) said segments are attached to said actuating means and are movable thereby within said opening.

4. The invention set forth in claim 1, wherein:
said support means include plural frames.

5. The invention set forth in claim 4, wherein:
said frames are spaced from one another.

6. The invention set forth in claim 5, wherein:
said frames are parallel to one another.

7. The invention set forth in claim 4, wherein:
said frames are joined together by said actuating means.

8. The invention set forth in claim 5, wherein:
said actuating means include housings disposed between said frames.

9. The invention set forth in claim 8, wherein:
said actuating means are angularly spaced from one another and extend radially into said opening.

10. The invention set forth in claim 8, wherein:
said actuating means are four in number and are angularly spaced at 90° intervals.

11. The invention set forth in claim 8, wherein:
a) said actuating means comprises plural fluid powered cylinders each having an extensible member; and,
b) each of said mold segments has a closure plate removably connected to one of said piston members.

12. The invention set forth in claim 1, wherein:
a) said opening is defined by the inner perimetric edge of said frame;
b) said edge defines plural recesses; and,
c) said actuating means moves said segments within said recesses.

13. A base for mounting a molding tool on a molding machine having stationary and movable platens and elongated bars slidably supporting said movable platen comprising:
window-like frame means supported by said bars intermediate said platens.

14. The invention set forth in claim 13, wherein:
said frame means has a perimetric edge which bears upon said bars.

15. The invention set forth in claim 14, wherein:
said perimetric edge projects between and beyond said bars.

16. The invention set forth in claim 13, wherein:
said frame means are plural and are supported in perpendicular relationship with said bars.

17. The invention set forth in claim 16, wherein:
said movable platen has an axis of movement which passes through said frames.

18. The invention sets forth in claim 13, wherein:
said frame has a separable, relatively movable section connected to said movable platen for movement thereby.

19. The invention set forth in claim 18, wherein:
said section is movably supported by elongated rods penetrating said section and supported by said platens.

20. A window-like base for the elements of a pattern forming tool, comprising:
at least one flat metal plate having its major central portion excised to provide an opening surrounded by a perimetric frame.

21. The invention set forth in claim 20, wherein:
said base includes a pair of said flat metal plates joined in side-to-side relationship.

22. The invention set forth in claim 21, wherein:
said frames are laterally spaced and parallel to one another.

23. The invention set forth in claim 20, wherein:
said frame has a separable segment to which an element of said tool is attached.
